(19) United States
(12) Patent Application Publication
(10) Pub. No.: US 2009/0271057 A1
(43) Pub. Date: Oct. 29, 2009

(54) Hybrid Vehicle Vibration Reduction System and Method

(75) Inventor: Kevin T. Stone, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE CORPORATION, Poway, CA (US)

(21) Appl. No.: 12/111,362

(22) Filed: Apr. 29, 2008

(51) Int. Cl. G06F 19/00

(52) U.S. Cl. 701/22

(57) ABSTRACT

A method for reducing vibration in a hybrid-electric vehicle including initiating a shut-down sequence of an internal combustion engine of the a hybrid-electric vehicle; providing an open port to at least one combustion chamber of the internal combustion engine; and shutting down the internal combustion engine.

### FIELD OF THE INVENTION

The field of the invention relates, in general, to hybrid electric vehicles (HEVS) and, in particular, to vibration reduction systems and methods for HEVs.

### BACKGROUND OF THE INVENTION

Vehicles are optimized to minimal noise, vibration, and harshness (NVH) when the engine of the vehicle operates at engine idle speed and at engine speeds above engine idle speed. Typical engine vibration is optimized for higher frequency/speed vibration. Low speed/low frequency vibration is more difficult to isolate.

During engine stopping and starting, the engine passes through rotation speeds in the range of approximately 0-800 rpm. This range is problematic for NVH resonance. NVH resonance is caused by compression pulses in the engine and fluctuations in flywheel speed (i.e., rotational speed of flywheel slows down and speeds up). The NVH resonance problems in this range are problematic for gasoline engines, which have a pressure during compression on the order of 120 psi, and especially problematic for diesel engines, which have a pressure during compression on the order of 400 psi.

The NVH resonance problem described above is acceptable in most present-day vehicles because such vehicles only have one start/stop per drive cycle. However, the NVH resonance problem is exacerbated in vehicles (e.g., HEVs) that experience frequent and numerous starts/stops per drive cycle (as much as every 90 seconds, 2-3 seconds for engine shut down). The NVH resonance problems are unacceptable for drivers/passengers of HEVs because of the frequency and duration of the NVH resonance.

### SUMMARY OF THE INVENTION

Accordingly, an aspect of the invention involves a system and method for reducing vibration in a hybrid-electric vehicle including an internal combustion engine. To reduce NVH resonance, an open port, preferably an open exhaust port, is provided in at least one combustion chamber of the internal combustion engine during a shut-down sequence of the internal combustion engine. This reduces NVH resonance by reducing the compression pressure in the at least one combustion chamber of the internal combustion engine during shut-down. In particular, this reduces changes in rotational inertia for the engine, thereby reducing engine vibration transferred to the chassis.

Another aspect of the invention involves a method for reducing vibration in a hybrid-electric vehicle, the hybrid-electric vehicle including an internal combustion engine. The method includes initiating a shut-down sequence of the internal combustion engine; providing an open port to at least one combustion chamber of the internal combustion engine; and shutting down the internal combustion engine.

### BRIEF DESCRIPTION OF THE DRAWINGS

The accompanying drawings, which are incorporated in and form a part of this specification, illustrate the logic flow of the invention and its embodiments, and together with the description, serve to explain the principles of this invention.

FIG. 1A is schematic of an embodiment of a hybrid electric vehicle that may include a system and method for reducing vibration in a hybrid-electric vehicle.

FIG. 1B is schematic of another embodiment of a hybrid electric vehicle that may include a system and method for reducing vibration in a hybrid-electric vehicle.

FIG. 2 is a schematic of an embodiment of a system for reducing vibration in a hybrid-electric vehicle.

FIG. 3 is a block diagram illustrating an exemplary computer as may be used in connection with the system(s) to carry out the method(s) described herein.

### DETAILED DESCRIPTION OF THE INVENTION

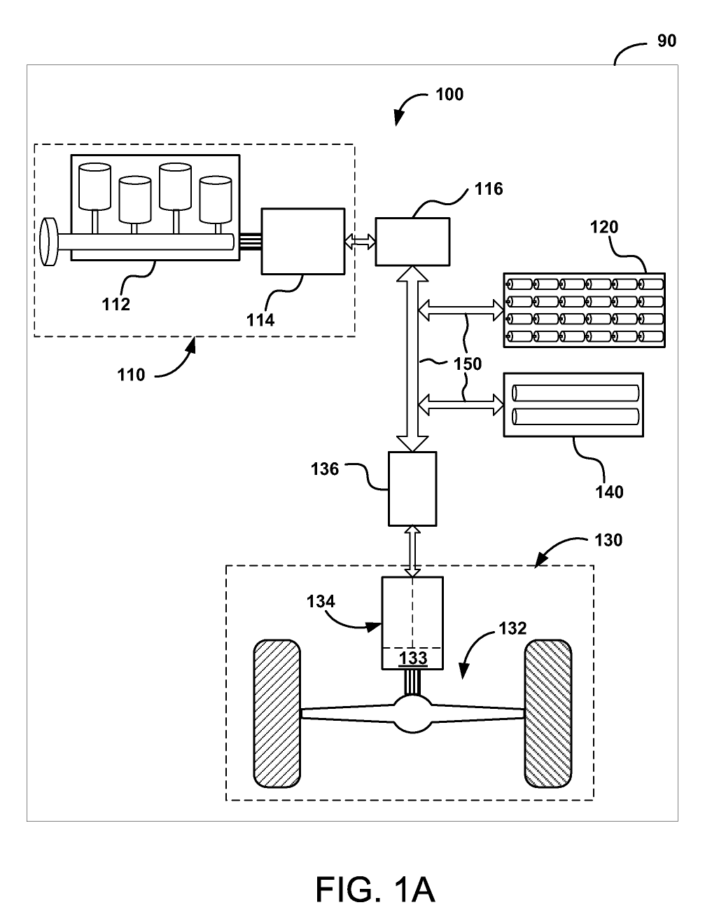

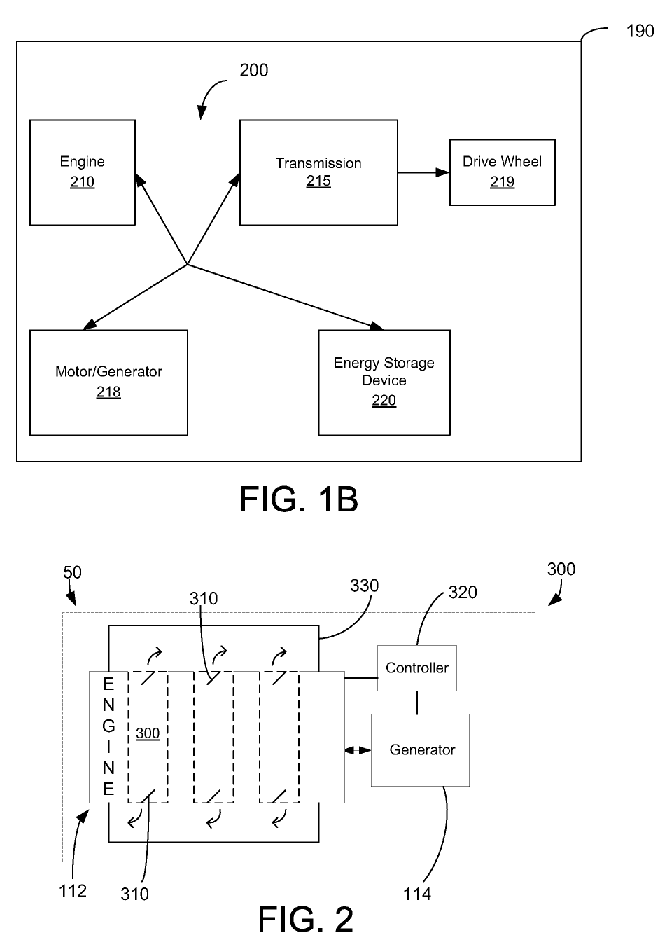

With reference to FIGS. 1A-2, embodiments of a system 50 and a method for reducing vibration in a hybrid-electric vehicle will be described. Before describing the system 50 and method for reducing vibration in a hybrid-electric vehicle, exemplary embodiments of hybrid electric vehicles 90, 190 including HEV drive systems 100, 200 that may include the system 50 and method will be described.

FIG. 1A illustrates an embodiment of a hybrid electric vehicle (HEV) 90, a vehicle which combines a conventional propulsion system with an on-board rechargeable energy storage system to achieve better fuel economy and cleaner emissions than a conventional vehicle. While HEVs are commonly associated with automobiles, heavy-duty hybrids also exist. In the U.S., a heavy-duty vehicle is legally defined as having a gross weight of over 8,500 lbs. A heavy-duty HEV will typically have a gross weight of over 10,000 lbs. and may include vehicles such as a metropolitan transit bus, a refuse collection truck, a semi tractor trailer, etc.

In a parallel configuration (not shown), the HEV 90 will commonly use an internal combustion engine (ICE) to provide mechanical power to the drive wheels and to generate electrical energy. The electrical energy is stored in an energy storage device, such as a battery pack or an ultracapacitor pack, and may be used to assist the drive wheels as needed, for example during acceleration.

FIG. 1A shows a HEV 90 having a series configuration. In a series configuration, an HEV drive system 100 will commonly use an energy generation source such as an “engine genset” 110 comprising an engine 112 (e.g., ICE, H-ICE, CNG, LNG, etc.) coupled to a generator 114, and an energy storage pack 120 (e.g., battery, ultracapacitor, flywheel, etc.) to provide electric propulsion power to its drive wheel propulsion assembly 130. In particular, the engine 112 (here illustrated as an ICE) will drive generator 114, which will generate electricity to power one or more electric propulsion motor(s) 134 and/or charge the energy storage 120. Energy storage 120 may solely power the one or more electric propulsion motor(s) 132 or may augment power provided by the engine genset 110. Multiple electric propulsion motor(s) 134 may be mechanically coupled via a combining gearbox 133 to provide increased aggregate torque to the drive wheel assembly 132 or increased reliability. Propulsion motor(s) 134 for heavy-duty vehicles (here, having a gross weight of over 10,000) may include two AC induction motors that produce 85 kW of power (×2) and have a rated DC voltage of 650 VDC.

Unlike lower rated systems, heavy-duty high power HEV drive system components may also generate substantial amounts of heat. Due to the high temperatures generated, high power electronic components such as the generator 114 and electric propulsion motor(s) 134 will typically be cooled (e.g., water-glycol cooled), and may also be included in the same cooling loop as the ICE 112.

Since the HEV drive system 100 may include multiple energy sources (i.e., engine genset 110, energy storage device 120, and drive wheel propulsion assembly 130 in regen-discussed below), in order to freely communicate power, these energy sources may then be electrically coupled to a power bus, in particular a DC high power bus 150. In this way, energy can be transferred between components of the high power hybrid drive system as needed.

The HEV 90 may further include both AC and DC high power systems. For example, the drive system 100 may generate, and run on, high power AC, but it may also convert it to DC for storage and/or transfer between components across the DC high power bus 150. Accordingly, the current may be converted via an inverter/rectifier 116, 136 or other suitable device (hereinafter “inverters” or “AC-DC converters”). Inverters 116, 136 for heavy-duty vehicles (i.e., having a gross weight of over 10,000) are costly, specialized components, which may include a special high frequency (e.g., 2-10 kHz) IGBT multiple phase water-glycol cooled inverter with a rated DC voltage of 650 VDC having a peak current of 300 A.

As illustrated, HEV drive system 100 includes a first inverter 116 interspersed between the generator 114 and the DC high power bus 150, and a second inverter 136 interspersed between the generator 134 and the DC high power bus 150. Here the inverters 116, 136 are shown as separate devices, however it is understood that their functionality can be incorporated into a single unit.

As a key added feature of HEV efficiency, the HEV 90 recaptures the kinetic energy of the vehicle via regenerative braking rather than dissipating kinetic energy as heat via friction braking. In particular, regenerative braking (“regen”) is where the electric propulsion motor(s) 134 are switched to operate as generators, and a reverse torque is applied to the drive wheel assembly 132. This torque results in a net braking force on the vehicle 90. As the vehicle 90 transfers its kinetic energy to the motor(s) 134, now operating as a generator(s), the vehicle 90 slows and electricity is generated. The electricity generated is then stored in the energy storage 120 to be used later in the drive cycle. This is particularly valuable for vehicles whose drive cycles include a significant amount of stopping and acceleration (e.g., metropolitan transit buses).

When the energy storage 120 reaches a predetermined capacity (e.g., fully charged), the drive wheel propulsion assembly 130 may continue to operate in regen for efficient braking. However, rather than storing the energy generated, any additional regenerated electricity may be dissipated through a resistive braking resistor 140. Typically, the braking resistor 140 will be included in the cooling loop of the ICE 112, and will dissipate the excess energy as heat.

Referring now to FIG. 1B, another embodiment of a HEV 190 is shown. The HEV 190 includes a HEV drive system 200 having an internal combustion engine 210 and a transmission 215. In this example embodiment, the HEV drive system 200 also includes an electric motor/generator 218 and an energy storage device 220. FIG. 1B shows generically that the engine 210, motor/generator 218, transmission 215, and/or energy storage device 220 are interconnected. In one example, the system 200 may be coupled together in a starter/generator configuration in which the motor/generator 218 is coupled between the engine 210 and transmission 215. Alternatively, the system 200 may be coupled in a parallel, series, or combined parallel-series configuration, such as where either the engine and/or the motor can drive the wheel 219, for example.

The transmission 215 may be a manual transmission, automatic transmission, or combinations thereof. Further, various additional components may be included, such as a torque converter, and/or other gears such as a final drive unit, etc. Transmission 215 is shown coupled to drive wheel 219, which in turn is in contact with a road surface.

The energy storage device 220 may include a battery, a capacitor, a flywheel, a hydraulic or pneumatic pressure vessel, among others and combinations thereof. The motor/generator 218 can be operated to absorb energy from vehicle motion and/or the engine and convert the absorbed energy to an energy form suitable for storage by the energy storage device 220. The motor/generator 218 can also be operated to supply an output (power, work, torque, speed, etc.) to the drive wheels 219 and/or engine 210 using stored energy.

In some embodiments, the motor 218 may be configured to also serve as a generator, thereby eliminating one or more separate generator devices. Alternatively, in some embodiments, a separate motor and generator can be used where the motor is configured to provide a motor output from the energy supplied by the battery, and the generator is configured to absorb output (e.g. power, torque, work, speed, etc.) from the engine 210 and/or transmission 215, and convert the absorbed output to energy storable by the energy storage device 220. The term motor will be used herein to describe a device that can provide the role of both a generator and a motor.

Various types of energy/torque transmissions may be used, such as, but not limited to, a mechanical coupling between the motor 218 and engine 210 or transmission 215. Further, any connections between the motor 218 and the energy storage device 220 may indicate transmission of a variety of energy forms such as electrical, mechanical, hydraulic, pneumatic, etc. For example, torque may be transmitted from engine 210 to drive the vehicle drive wheels 219 via transmission 215. As described above motor 218 may be configured to operate in a generator mode and/or a motor mode. In a generator mode, system 218 absorbs some or all of the output from engine 210 and/or transmission 215, which reduces the amount of drive output delivered to the drive wheel 219, or the amount of braking torque to the drive wheel 219. Such operation may be employed, for example, to achieve efficiency gains through regenerative braking, improved engine efficiency, etc. Further, the output received by system 200 may be used to charge energy storage device 220. In motor mode, the system 200 may supply mechanical output to engine 210 and/or transmission 215, for example by using electrical energy stored in an electric battery.

Hybrid propulsion embodiments may include full hybrid systems, in which the vehicle can run on just the engine 210, just the motor 218, or a combination of both. Assist or mild hybrid configurations may also be employed, in which the engine 210 is the primary torque source, with the hybrid propulsion system acting to start the engine 210 and to selectively deliver added torque, for example during tip-in or other conditions. Further still, starter/generator and/or smart alternator systems may also be used. In any case, the hybrid propulsion system 200 is able to utilize the motor 218 to supply and/or absorb torque during vehicle operation, such as conditions other than just engine starting as compared to a conventional starter motor. For example, motor 218 may be configured to “force stop” the engine 210 by applying a torque to its crankshaft.

With reference to FIG. 2, the system 50 for reducing vibration in a hybrid-electric vehicle 90, 190 will now be described. As shown in FIG. 2, the internal combustion engine 112 (e.g., gasoline engine, diesel engine) includes a plurality of combustion chambers/cylinders 300 with pistons (shown in FIG. 1A) reciprocating therein in a well-known manner. The engine 112 includes one or more ports 310 controllable by controller 320 for opening, closing, and timing the port(s) 310. The one or more ports 310 may include one or more of, but not by way of limitation, intake valve ports, exhaust valve ports, and dedicated pressure release ports. In a preferred embodiment, the one or more ports 310 include one or more electrically-controlled exhaust valves coupled to exhaust passage(s) 330.

Alternately, when independent valve control is not an option, the one or more ports 310 may include the spark plug/glow plug ports using specially adapted park plug/glow plugs. Engine 112 will typically include a port to insert a fuel ignition device such as a spark plug or glow plug. A specially adapted spark plug/glow plug may be configured to include an openable port, while retaining to the functionality of the ignition source. In this embodiment, controller 320 may be configured to open and close the port(s) 310 as required. Although, port(s) 310 may be vented to ambient, it is preferable to plumb port(s) 310 to an exit path such as into the exhaust system.

An exemplary method of using the system 50 for reducing vibration in a hybrid-electric vehicle 90, 190 will now be described. The method is preferably controlled by the controller 320, which may be the engine control system or a dedicated controller. The controller 320 first determines that engine operation is no longer necessary based on predetermined parameters. For example, according to one embodiment this determination may be based on received output from an Idle-Stop or Start-Stop algorithm, such as described in US Patent Application Publication US 2007/0124037, hereby incorporated by reference.

If the controller 320 determines that engine operation is no longer necessary, a shut-down sequence is initiated. The shut-down sequence typically will include communication of control signals, reconfiguration software related items, shutting off the ignition source, shutting off the fuel supply, etc.

According to a preferred embodiment, the chamber(s)/cylinder(s) 300 are cleared of fuel and exhaust. The chamber(s)/cylinder(s) 300 may be cleared by, first, shutting off fuel supply to the chamber(s)/cylinder(s) 300, and, then, cycling the engine 1-2 times (at least 2 crankshaft rotations) to clear most fuel from the combustion cylinders 300. The port(s) 310 may be operated normally for the first 2 crankshaft revolutions or 1 complete cycle (to clear the chamber). The method may further include a decision step confirming that the chamber(s)/cylinder(s) 300 are clear before opening the port(s) 310. Confirmation that the chamber(s)/cylinder(s) 300 are clear can be performed by measuring fuel/air in exhaust (e.g., reading emissions sensors).

The method may further include a decision step confirming that the combustion chambers are substantially depressurized before allowing port(s) 310 to open. This reduces exhaust noise (e.g., “popping” or pressure pulses). According to one embodiment, controller 320 may confirm that the piston is in the proper position. For example, if the piston has entered a compression stroke (if cylinder position is anywhere between fuel compression stage and top dead center), the port 310 is not opened. Preferably, the port 310 is opened when the piston is at the bottom of its stroke or when chamber pressure is negative to nominal (i.e., pressure substantially equal to atmospheric). The piston position is determined using traditional positioning data (e.g., crank position sensors, ignition system signals). Alternately, piston position may be inferred by referring to generator shaft position. Upon receiving confirmation that the piston is in the proper position based on the associated generator shaft position, the port(s) 310 is/are opened.

According to one alternate embodiment, controller 320 may infer that the combustion chambers are substantially depressurized by referring to the communications of high power HEV electronic components (e.g., generator). The HEV high voltage system includes highly accurate devices typically having sophisticated communications. Data may be obtained from the communications of the generator. For example the rate of engine spin down may be determined from generator information provided by the generator. As the combustion chambers are depressurized this will be reflected in the rate of change of the spin down. This can then be correlated to the chamber pressure. Also for example, the presence of oscillations during engine spin down may be determined from generator information provided by the generator. The oscillations are the result of pressure pulses in the engine cylinders. As the combustion chambers are depressurized, generator oscillations decrease, and as above, this can then be correlated to the chamber pressure.

Once the shut-down sequence is initiated the method includes providing an open port to the engine combustion chambers. As discussed above, the opening and closing of the port(s) 310 may be controlled by variable valves that are hydraulically opened and/or electrically opened (e.g., via solenoid). In a preferred embodiment, the valves are solenoid opened because this may result in a quicker response. The valves may include any combination of the intake valves, exhaust valves, and a dedicated pressure release valve (which may be integrated into an existing engine port such as the ignition port.

Control of the port(s) 310 may be via one-way signaling (i.e., control signal sent to open port(s) 310; however, in a preferred embodiment, control of the port(s) 310 is by two-way communication (e.g., control signaling sent to port(s) 310 and port(s) 310 sends feedback (for example, port(s) 310 send back confirmation that valve(s) have opened--this information can be used for redundant safeguard control preventing ignition with open ports, this information may be recorded, and/or this information may be made available to other vehicle systems)). This control communication complies with communication standards such as, but not limited to, CAN, J1939; however, in an alternative embodiment, control communication is via proprietary communication protocols.

In a preferred embodiment, the port(s) 310 is/are open for all 4 engine strokes or stages (intake stroke, compression stroke, power stroke, exhaust stroke). After the clearance of chamber(s) 300, the intake port(s) 310 remain closed. Alternately, after the clearance of chamber(s) 300, the intake port(s) 310 remain open together with exhaust port(s) 310. The sequence may be initiated without clearing fuel, but it is not preferred.

In the above embodiments, the port(s) 310 are opened and closed using variable valves. In a further embodiment, the port(s) are opened and closed using non-variable valves. For example, but not by way of limitation, an exemplary non-variable valve assembly uses a combination ignition plug port and engine port that can be commanded open or closed. In an internal combustion gasoline engine, the ignition plug port is a spark plug port. In a diesel engine, the ignition plug port is a glow plug port. One or more solenoids are preferably used to open the port(s) 310. The non-variable valve assembly preferably includes one or more plumb port(s) away from the engine compartment (e.g., to the exhaust system).

In a further implementation of the above embodiments, in addition to the system 50 providing vibration reduction, the system 50 includes the generator 114 engaged against the engine 112, applying a torque to force to engine 112 to stop more rapidly (e.g. within 1-4 engine rotations), thus spending less time in the resonance range.

In addition to using the system 50 to reduce vibrations during engine shut down, in a further implementation of the above embodiments, the system 50 is used to reduce vibrations during engine start up. In this implementation, the system 50 causes the generator 114 to act as a motor to spin the engine 112 without engine pressure until rpm is sufficiently high (as determined by rotational inertia, passing through the resonance range, and/or reaching idle speed), then the port(s) 310 is/are closed, and combustion is started in the engine 112.

Thus, the system 50 and method are advantageous in that, by opening the port(s) 310 (i.e., opening the cylinder(s) 300), pressure is not built up, and as a consequence, pressure pulsations are no longer produced. Without the pressure pulsations, the resonance effects are reduced. Further, with resonance effects reduced, it may not be necessary to force stop the engine 112 (i.e., the engine 112 is allowed to wind down more slowly). This reduces energy consumption associated with forced stop and wear/fatigue from the forces applied to the engine 112 during forced stop. When the system 50 and method are applied to starting, the additional efficiency advantage of reducing energy required to start engine against pressurized cylinders 300 is realized.

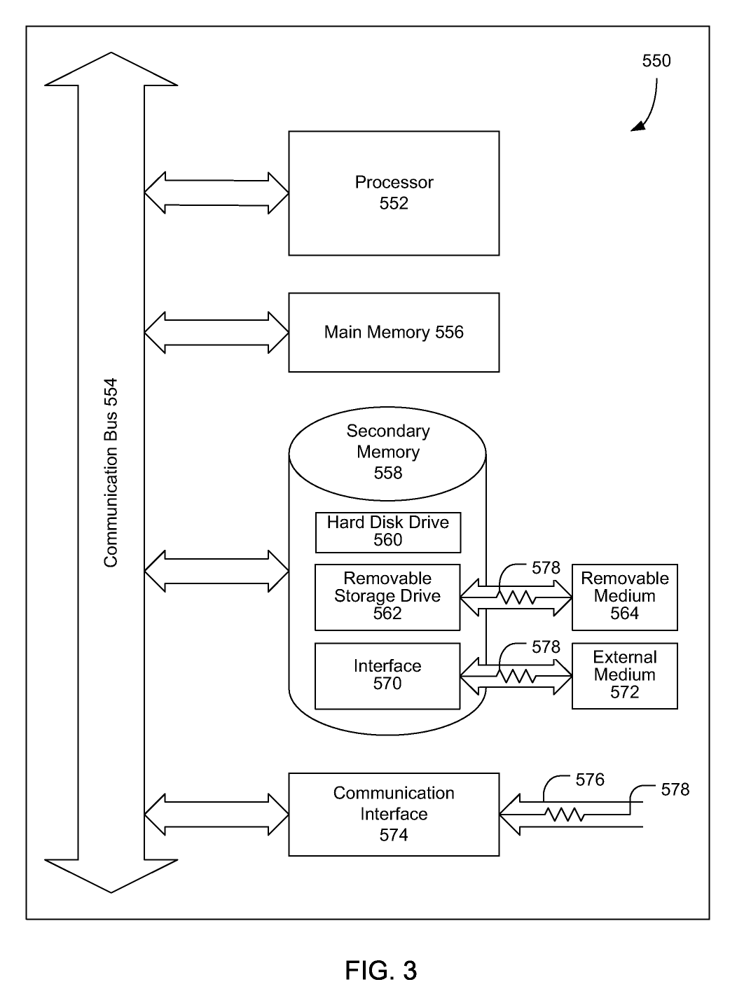

FIG. 3 is a block diagram illustrating an exemplary computer system 550 that may be used in connection with the various embodiments described herein. For example, the computer system 550 (or various components or combinations of components of the computer system 550) may be used in conjunction with the controller 320 or to control the functions described herein. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method for reducing vibration in a hybrid-electric vehicle, the hybrid-electric vehicle including an internal combustion engine, the method comprising:
initiating a shut-down sequence of the internal combustion engine;
providing an open port to at least one combustion chamber of the internal combustion engine; and,
shutting down the internal combustion engine.

2. The method of claim 1, further comprising automatically determining that engine operation is no longer necessary based on predetermined parameters; and,
wherein the initiating the shut-down sequence comprises automatically initiating the shut-down sequence in response to the automatically determining that engine operation is no longer necessary.

3. The method of claim 2, wherein the automatically determining that engine operation is no longer necessary comprises receiving an output from an Idle-Stop algorithm.

4. The method of claim 1, further comprising shutting off ignition to the internal combustion engine before the providing the open port to at least one combustion chamber of the internal combustion engine.

5. The method of claim 1, further comprising shutting off fuel supply to the internal combustion engine before the providing the open port to at least one combustion chamber of the internal combustion engine.

6. The method of claim 5, further comprising cycling the engine one or more times to clear fuel from the internal combustion engine.

7. The method of claim 5, further comprising confirming that the at least one combustion chamber of the internal combustion engine is clear of fuel before providing an open port to at least one combustion chamber of the internal combustion engine.

8. The method of claim 7, wherein the confirming that the at least one combustion chamber of the internal combustion engine is clear of fuel comprises measuring at least one of fuel and air in exhaust from the at least one combustion chamber via reading one or more emissions sensors.

9. The method of claim 1, further comprising confirming that the at least one combustion chamber is substantially depressurized before the providing the open port to at least one combustion chamber of the internal combustion engine.

10. The method of claim 9, wherein the internal combustion engine includes at least one combustion chamber with a reciprocating piston therein; and,
wherein the confirming that the at least one combustion chamber is substantially depressurized comprises determining the position of the reciprocating piston.

11. The method of claim 9, wherein the confirming that the at least one combustion chamber is substantially depressurized comprises determining at least one of the piston has not entered a compression stroke, the piston is at the bottom of its stroke, combustion chamber pressure is negative, and combustion chamber pressure is substantially equal to zero.

12. The method of claim 9, wherein the confirming that the at least one combustion chamber is sufficiently depressurized comprises at least one of determining the rate of engine spin down and detecting the presence of oscillations associated with chamber pressurizations during engine spin down.

13. The method of claim 1, wherein the internal combustion engine includes at least one electrically-controlled exhaust valve; and,
wherein the providing the open port to the at least one combustion chamber of the internal combustion engine comprises opening the at least one electrically-controlled exhaust valve.

14. The method of claim 1, wherein the internal combustion engine includes multiple valves that open to form the open port; and,
wherein the providing the open port to the at least one combustion chamber of the internal combustion engine comprises opening all of the valves to provide multiple open ports to multiple combustion chambers.

15. The method of claim 1, wherein the internal combustion engine includes multiple valves that open to form the open port, and the multiple valves are at least one of hydraulically opened and solenoid opened.

16. The method of claim 1, wherein the providing the open port to at least one combustion chamber comprises providing an open exhaust port to at least one combustion chamber.

17. The method of claim 15, wherein the providing the open port to at least one combustion chamber further comprises providing an open intake port to at least one combustion chamber.

18. The method of claim 1, wherein the providing the open port to at least one combustion chamber comprises providing an open ignition plug port to at least one combustion chamber.

19. The method of claim 1, wherein control of the port is by at least one of one-way communication and two-way communication.

20. The method of claim 19, wherein the control is by at least one of the following control protocols: CAN, J1939, and a proprietary communication protocol.

21. The method of claim 1, wherein the port is open for all four of the following strokes: intake stroke, compression stroke, power stroke, and exhaust stroke.

22 The method of claim 1, wherein the hybrid-electric vehicle includes a generator operatively coupled to the internal combustion engine, the method further comprising applying a torque by the generator to the internal combustion engine forcing the internal combustion engine to stop rapidly, in four or less engine rotations.

23. The method of claim 1, further comprising force starting the internal combustion engine using a generator to apply a torque to spin the internal combustion engine without engine pressure until rotational speed of the engine reaches a predetermined lower limit.

24. The method of claim 23, further comprising:
providing an open port to at least one combustion chamber of the internal combustion engine during force starting until the rotational speed of the engine reaches a predetermined lower limit; and
when the rotational speed of the engine reaches a predetermined lower limit, closing the open port to at least one combustion chamber and starting combustion in at least one combustion chamber.
